(19) United States
(12) Patent Application Publication
(10) Pub. No.: US 2024/0012680 A1
(43) Pub. Date: Jan. 11, 2024

(54) TECHNIQUES FOR INTER-CLOUD FEDERATED LEARNING

(71) Applicant: VMware, Inc., Palo Alto, CA (US)

(72) Inventors: Fangchi Wang, Beijing (CN); Hai Ning Zhang, Beijing (CN); Layne Lin Peng, Shanghai (CN); Renming Zhao, Beijing (CN); Siyu Qiu, Beijing (CN)

(21) Appl. No.: 17/874,182

(22) Filed: Jul. 26, 2022

(30) Foreign Application Priority Data
Jul. 7, 2022 (WO) PCT/CN2022/104429

(51) Int. Cl. G06F 9/48; G06F 9/50; G06F 9/445

(52) U.S. Cl. CPC G06F 9/4881; G06F 9/5072; G06F 9/44505

(57) ABSTRACT

Techniques for facilitating inter-cloud federated learning (FL) are provided. In one set of embodiments, these techniques comprise an FL lifecycle manager that enables users to centrally manage the lifecycles of FL components across different cloud platforms. The lifecycle management operations enabled by the FL lifecycle manager can include deploying/installing FL components on the cloud platforms, updating the components, and uninstalling the components. In a further set of embodiments, these techniques comprise an FL job manager that enables users to centrally manage the execution of FL training runs (i.e., FL jobs) on FL components that have been deployed via the FL lifecycle manager. For example, the FL job manager can enable users to define the parameters and configuration of an FL job, initiate the job, monitor the job's status, take actions on the running job, and collect the job's results.

### CROSS-REFERENCES TO RELATED APPLICATIONS

The present application claims priority under 35 U.S.C. 119(a)-(d) to Foreign Application Serial No. PCT/CN2022/104429 filed in China on Jul. 7, 2022 and entitled “TECHNIQUES FOR INTER-CLOUD FEDERATED LEARNING.” The entire contents of this foreign application are incorporated herein by reference for all purposes.

### BACKGROUND

Unless otherwise indicated, the subject matter described in this section is not prior art to the claims of the present application and is not admitted as being prior art by inclusion in this section.

In recent years, it has become common for organizations to run their software workloads “in the cloud” (i.e., on remote servers accessible via the Internet) using public cloud platforms such as Amazon Web Services (AWS), Microsoft Azure, Google Cloud, and the like. For reasons such as cost efficiency, feature availability, and network constraints, many organizations use multiple different cloud platforms for hosting the same or different workloads. This is referred to as a multi-cloud or inter-cloud model.

One challenge with the multi-cloud/inter-cloud model is that an organization's data will be distributed across disparate cloud platforms and, due to cost and/or data privacy concerns, typically cannot be transferred out of those locations. This makes it difficult for the organization to apply machine learning (ML) to the entirety of its data in order to, e.g., optimize business processes, perform data analytics, and so on. A solution to this problem is to leverage federated learning, which is an ML paradigm that enables multiple parties to jointly train an ML model on training data that is spread across the parties while keeping the data samples local to each party private. However, there are no existing methods for managing and running federated learning in multi-cloud/inter-cloud scenarios.

### BRIEF DESCRIPTION OF THE DRAWINGS

FIG. 1 depicts an example environment.

FIG. 2 depicts a flowchart of an example federated learning workflow.

FIG. 3 depicts a version of the environment of FIG. 1 that includes an inter-cloud federated learning platform service according to certain embodiments.

FIG. 4 depicts a flowchart for deploying a federated learning component on one or more disparate cloud platforms according to certain embodiments.

FIG. 5 depicts a flowchart for initiating and managing a federated learning job across one or more disparate cloud platforms according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof

### 1. Example Environment and Solution Architecture

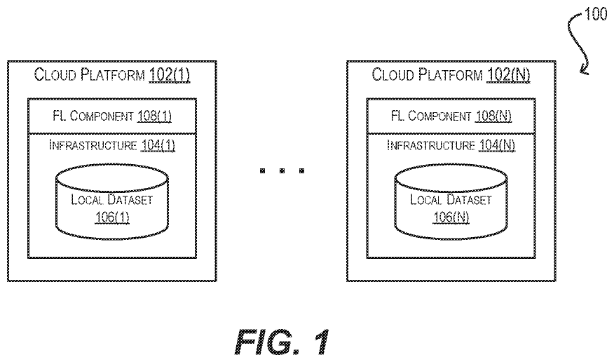

Embodiments of the present disclosure are directed to techniques for facilitating inter-cloud federated learning (i.e., federated learning that is performed on training data spread across multiple different cloud platforms). FIG. 1 is a simplified block diagram of an example environment 100 in which these techniques may be implemented. As shown, environment 100 includes a plurality of different cloud platforms 102(1)-(N), each comprising an infrastructure 104. Infrastructure 104 includes compute resources, storage resources, and/or other types of resources (e.g., networking, etc.) that make up the physical infrastructure of its corresponding cloud platform 104. In one set of embodiments, each cloud platform 102 may be a public cloud platform (e.g., AWS, Azure, Google Cloud, etc.) that is owned and maintained by a public cloud provider and is made available for use by different organizations/customers. In other embodiments, one or more of cloud platforms 102(1)-(N) may be a private cloud platform that is reserved for use by a single organization.

In FIG. 1, it is assumed that an organization (or a federation of organizations) has adopted a multi-cloud/inter-cloud model and thus has deployed one or more software workloads across disparate cloud platforms 102(1)-(N), resulting in a local dataset 106 in each infrastructure 104. For example, local dataset 106(1) may correspond to development-related data (e.g., source code, etc.) for the organization(s), local dataset 106(2) may correspond to human resources data for the organization(s), local dataset 106(3) may correspond to customer data for the organization(s), and so on. As mentioned previously, in this type of multi-cloud/inter-cloud setting, local datasets 106(1)-(N) often cannot be transferred out of their respective cloud platforms for cost and/or data privacy reasons. Accordingly, in order to apply machine learning to the totality of local datasets 106(1)-(N), federated learning is needed.

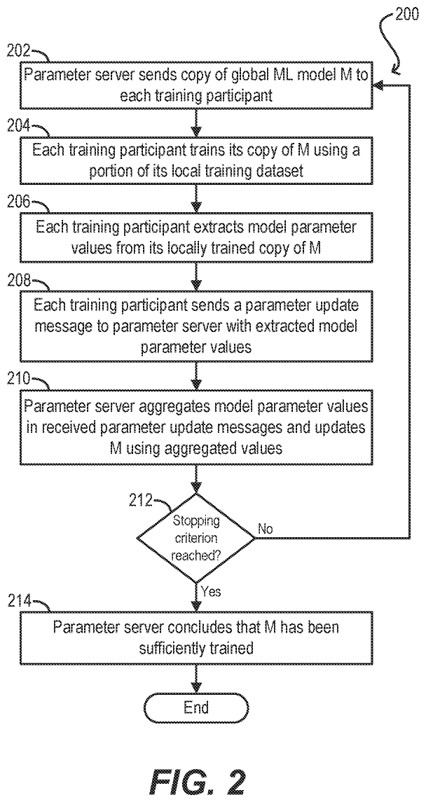

Generally speaking, federated learning can be achieved in this context via components 108(1)-(N) of a federated learning (FL) framework that are deployed across cloud platforms 102(1)-(N). For example, FL components 108(1)-(N) may be components of the OpenFL framework, the FATE framework, or the like. FIG. 2 depicts a flowchart 200 of a federated learning process that may be executed by FL components 108(1)-(N) on respective datasets 106(1)-(N) according to certain embodiments. It this example, it is assumed that one of the FL components acts as a central “parameter server” that receives ML model parameter updates from the other FL components (referred to as “training participants”) and aggregates the parameter updates to train a global ML model M. In alternative FL implementations such as peer-to-peer federated learning, different workflows may be employed.

Starting with step 202, the parameter server can send a copy of the current version of global ML model M to each training participant. In response, each training participant can train its copy of M using a portion of the participant's local training dataset (i.e., local dataset 106 in FIG. 1) (step 204), extract model parameter values from the locally trained copy of M (step 206), and send a parameter update message including the extracted model parameter values to the parameter server (step 208).

At step 210, the parameter server can receive the parameter update messages sent by the training participants, aggregate the model parameter values included in those messages, and update global ML model M using the aggregated values. The parameter server can then check whether a predefined criterion for concluding the training process has been met (step 212). This criterion may be, e.g., a desired level of accuracy for global ML model M, a desired number of training rounds, or something else. If the answer at block 212 is no, flowchart 200 can return to step 202 in order to repeat the foregoing steps as part of a next round for training global ML model M.

However, if the answer at block 212 is yes, the parameter server can conclude that global ML model M is sufficiently trained (or in other words, has converged) and terminate the process (step 214). The parameter server may also send a final copy of global ML model M to each training participant. The end result of flowchart 200 is that global ML model M is trained in accordance with the training participants' local training datasets, without revealing those datasets to each other.

One key issue with implementing federated learning in a multi-cloud/inter-cloud setting as shown in FIG. 1 is that each cloud platform 102 may employ different access methods and application programming interfaces (APIs) for communicating with the platform and for deploying and managing FL components 108(1)-(N). This makes it difficult for the organization(s) that own local datasets 106(1)-(N) to carry out federated learning across the cloud platforms is an efficient manner.

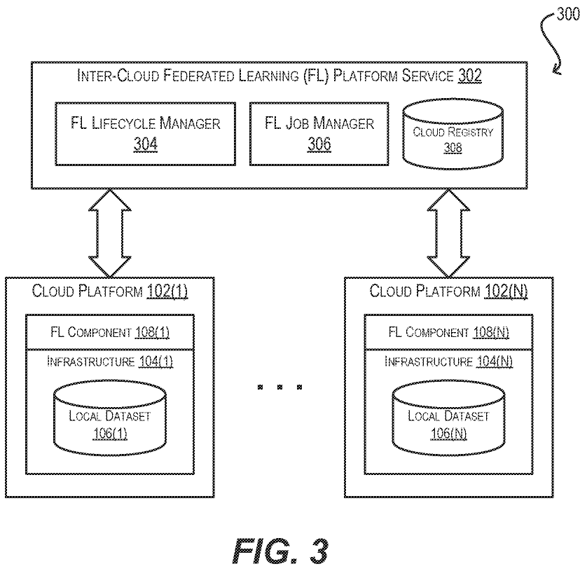

To address the foregoing and other related issues, FIG. 3 depicts an enhanced version of environment 100 (i.e., environment 300) that includes a novel inter-cloud FL platform service 302 comprising an FL lifecycle manager 304, an FL job manager 306, and a cloud registry 308. In one set of embodiments, inter-cloud FL platform service 302 may be implemented as a Software-as-a-Service (SaaS) offering that runs on a public cloud platform such as one of platforms 102(1)-(N). In other embodiments, inter-cloud FL platform service 302 may be implemented as a standalone service running on, e.g., an on-premises data center of an organization.

At a high level, inter-cloud FL platform service 302 can facilitate the end-to-end management of federated learning across multiple cloud platforms in a streamlined and efficient fashion. For example, as detailed in section (2) below, FL lifecycle manager 304 can implement techniques that enables users to centrally manage the lifecycles of FL components 108(1)-(N) across cloud platforms 102(1)-(N). These lifecycle management operations can include deploying/installing FL components 108(1)-(N) on respective cloud platforms 102(1)-(N), updating the components, and uninstalling the components. These operations can also include synchronizing infrastructure and/or FL control plane information across FL components 108(1)-(N), such as their network endpoint addresses, access keys, and so on.

Significantly, FL lifecycle manager 304 has knowledge of the unique communication interfaces/APIs used by each cloud platform 102 via registry entries held in cloud registry 308. Accordingly, as part of enabling the foregoing lifecycle management operations, FL lifecycle manager 304 can automatically interact with each cloud platform 102 using the communication mechanisms appropriate for that platform, thereby hiding that complexity from service 302′s end-users.

Further, as detailed in section (3) below, FL job manager 306 can implement techniques that enables users to centrally manage the execution of FL training runs (referred to herein as FL jobs) on FL components 108(1)-(N) once they have been deployed across cloud platforms 102(1)-(N). For example, FL job manager 306 can enable users to define the parameters and configuration of an FL job to be run on one or more of FL components 108(1)-(N), initiate the FL job, monitor the job's status, take actions on the running job (e.g., pause, cancel, etc.), and collect the job's results. Like FL lifecycle manager 304, FL job manager 306 has knowledge of the unique communication interfaces/APIs used by each cloud platform 102 via cloud registry 308. In addition, FLG job manager 306 has knowledge of the FL components that have been deployed across cloud platforms 102(1)-(N) via FL lifecycle manager 304. Accordingly, FLG job manager 306 can automate various aspects of the job management process (e.g., communicating with each cloud platform using cloud-specific APIs, identifying and communicating with deployed FL components, etc.) that would otherwise need to be handled manually.

It should be appreciated that FIGS. 1-3 are illustrative and not intended to limit embodiments of the present disclosure. For instance, as mentioned above, flowchart 200 of FIG. 2 illustrates one example federated learning process that relies on a central parameter server and other implementations (using, e.g., a peer-to-peer approach) are possible.

Further, the various entities shown in FIGS. 1 and 3 may be organized according to different arrangements/configurations or may include subcomponents or functions that are not specifically described. One of ordinary skill in the art will recognize other variations, modifications, and alternatives.

### 2. FL Lifecycle Management

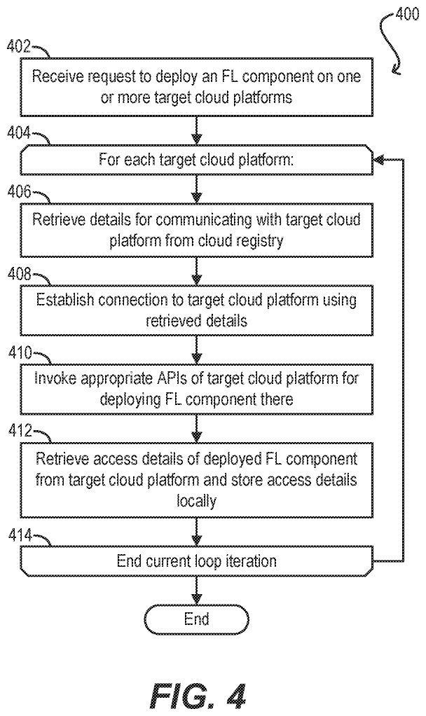

FIG. 4 depicts a flowchart 400 that may be performed by FL lifecycle manager 304 of inter-cloud FL platform service 302 for enabling the deployment of one or more FL components on cloud platforms 102(1)-(N) according to certain embodiments. Flowchart 400 assumes that each cloud platform 102 is registered with inter-cloud FL platform service 302 and details for communicating with that cloud platform are held within a registry entry stored in cloud registry 308.

For example, if cloud platform 102(1) implements a Kubernetes cluster environment, the registry entry for cloud platform 102(1) can include a kubeconfig file that contains connection information for the cluster's API server and corresponding access tokens or certificates. As another example, if cloud platform 102(2) implements an AWS Elastic Cloud 2 (EC2) environment, the registry entry for cloud platform 102(2) can include AWS access credentials and region information. As yet another example, if cloud platform 102(3) implements a VMware Cloud Director (VCD) environment, the registry entry for cloud platform 102(3) can include a VCD server address, a type of authorization, and authorization credentials.

Starting with step 402, FL lifecycle manager 304 can receive, from a user or automated agent/program, a request to deploy an FL component on one or more of cloud platforms 102(1)-(N). For example, the request can be received from an administrator of the organization(s) that own local datasets 106(1)-(N) distributed across cloud platforms 102(1)-(N). The request can include, among other things, the type (e.g., framework) of the FL component to be deployed and the “target” cloud platforms that will act as deployment targets for that component.

At step 404, FL lifecycle manager 304 can enter a loop for each target cloud platform specified in the request. Within this loop, FLG lifecycle manager 304 can retrieve from cloud registry 308 the details for communicating with the target cloud platform (step 406), establish a connection to the target cloud platform using those details (step 408), and invoke appropriate APIs of the target cloud platform for deploying the FL component there (step 410). For example, if the target cloud platform implements a Kubernetes cluster environment, FL lifecycle manager 304 can invoke Kubernetes APIs (such as APIs for creating a Deployment object, Service object, etc.) that result in the deployment and launching of the FL component on that Kubernetes cluster environment. Alternatively, if the target cloud platform implements an AWS EC2 environment, FL lifecycle manager 304 can invoke AWS APIs (such as, e.g., APIs for creating an EC2 instance, running commands in the instance, etc.) that result in the deployment and launching of the FL component on that AWS EC2 environment. Alternatively, if the target cloud platform implements a VCD environment, FL lifecycle manager 304 can invoke VCD APIs (such as, e.g., APIs for creating a session, creating a vAPP, configuring guest customization scripts, etc.) that result in the deployment and launching of the FL component on that VCD environment.

Once the FL component is deployed and launched, FL lifecycle manager 304 can retrieve access information regarding the deployed component (e.g., network address, access keys, etc.) from the target cloud platform and store this information locally for later use by, e.g., FL job manager 306 (step 412). FL lifecycle manager 304 may also synchronize the FL component's access information with other FL components of the same type/framework running on other cloud platforms so that the components can communicate with each other at the time of executing an FL job. As with the deployment process at step 410, FLG lifecycle manager 304 can invoke APIs appropriate to the target cloud platform in order to retrieving this access information.

FL lifecycle manager 304 can then reach the end of the current loop iteration (step 414) and return to the top of the loop in order to deploy the FL component on the next target cloud platform. In some embodiments, rather than looping through steps 404-414 in a sequential manner for each target cloud platform, FLG lifecycle manager 304 can process the target cloud platforms simultaneously (via, e.g., separate concurrent threads). Finally, upon processing all target cloud platforms, the flowchart can end. Although not shown, in various embodiments similar workflows may be implemented by FL lifecycle manager 304 for handling update or uninstall requests with respect to the FL components deployed via flowchart 400.

### 3. FL Job Management

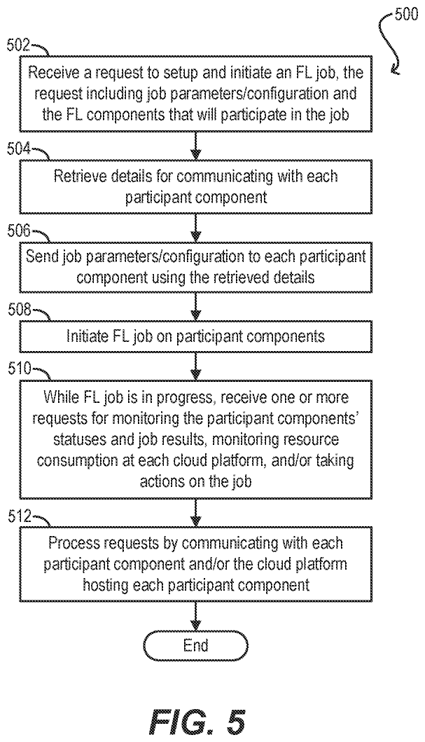

FIG. 5 depicts a flowchart 500 that may be performed by FL job manager 306 for initiating an FL job using one or more FL components 108(1)-(N) and managing the job while it is in progress according to certain embodiments. Flowchart 500 assumes that the FL components have been deployed across cloud platforms 102(1)-(N) via FL lifecycle manager 304 per flowchart 400 of FIG. 4.

Starting with step 502, FL job manager 306 can receive, from a user or automated agent/program, a request to setup and initiate an FL job. For example, the request can be received from a data scientist associated with the organization(s) that own local datasets 106(1)-(N). The request can include, among other things, parameters and configuration information for the FL job, including selections of the specific FL components that will participate in the job.

At steps 504 and 506, FL job manager 306 can retrieve, from FL lifecycle manager 304 and/or cloud registry 308, details for communicating with each participant component and can send the job parameters/configuration to that participant component using its corresponding communication details, thereby readying the participant component to run the FL job. In some embodiments, as part of step 506, FL job manager 306 can also automatically set certain cloud-specific configurations in the cloud platform hosting each participant component, such as limiting the amount of resources the participant component can consume as part of running the FL job.

Once each participant component has been appropriately configured, FL job manager 306 can initiate the FL job on the participant components (step 508). Then, while the FL job is in progress, FL job manager 306 can receive one or more requests for (1) monitoring the participant components' statuses and job results, (2) monitoring resource consumption at each cloud platform, and/or (3) taking certain job actions such as pausing the FL job, canceling the FL job, retrying the FL job, or dynamically adjusting certain job parameters (step 510), and can process the requests by communicating with each participant component and/or the cloud platform hosting that application (step 512).

For example, if any of the requests pertains to (1) (i.e., monitoring participant components' statuses and results), FL job manager 306 can communicate with each participant component using the access information collected by FL lifecycle manager 304 and thereby retrieve status and result information. Alternatively, if any of the requests pertain to (2) (i.e., monitoring cloud resource consumption), FLG job manager 306 can invoke cloud management APIs appropriate for the cloud platform hosting each participant component and thereby retrieve resource consumption information. Alternatively, if any of the requests pertain to (3) (i.e., taking certain job actions), FL job manager 306 can apply these actions to each participant component.

Finally, upon completion of the FL job, the flowchart can end.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system, a first request for deploying a component of a federated learning (FL) framework on a cloud platform in a plurality of cloud platforms, wherein the plurality of cloud platforms store local datasets, and wherein the component is designed to work in concert with other components of the FL framework deployed on other cloud platforms in the plurality of cloud platforms in order to train a machine learning (ML) model on the local datasets without transferring the local datasets outside of their respective cloud platforms;
retrieving, by the computer system, details for communicating with the cloud platform; and
deploying, by the computer system, the component on the cloud platform in accordance with the retrieved details.

2. The method of claim 1 wherein the plurality of cloud platforms include different public cloud platforms.

3. The method of claim 1 wherein the plurality of cloud platforms include at least one public cloud platform and at least one private cloud platform.

4. The method of claim 1 further comprising, subsequently to the deploying:
retrieving information for accessing the component; and
synchronizing the information with the other components.

5. The method of claim 1 wherein the details for communicating with the cloud platform are stored in a cloud registry maintained by the computer system.

6. The method of claim 1 further comprising:
receiving a second request to configure and initiate an FL job on the component and the other components, the second request including job parameters and configuration information;
for each component:
retrieving further details for communicating with the component; and
sending the job parameters and configuration information to the component in accordance with the retrieved further details; and
initiating the FL job on the component and the other components.

7. The method of claim 6 further comprising:
receiving a third request to monitor a status of the component or the other components, monitor cloud resource consumption for the component or the other components, or take one or more actions on the in-progress FL job; and
processing the third request by communicating with the component or the other components, or with one or more of the plurality of cloud platforms.

8. A non-transitory computer readable storage medium having stored thereon program code executable by a computer system, the program code causing the computer system to execute a method comprising:
receiving a first request for deploying a component of a federated learning (FL) framework on a cloud platform in a plurality of cloud platforms, wherein the plurality of cloud platforms store local datasets, and wherein the component is designed to work in concert with other components of the FL framework deployed on other cloud platforms in the plurality of cloud platforms in order to train a machine learning (ML) model on the local datasets without transferring the local datasets outside of their respective cloud platforms;
retrieving details for communicating with the cloud platform; and
deploying the component on the cloud platform in accordance with the retrieved details.

9. The non-transitory computer readable storage medium of claim 8 wherein the plurality of cloud platforms include different public cloud platforms.

10. The non-transitory computer readable storage medium of claim 8 wherein the plurality of cloud platforms include at least one public cloud platform and at least one private cloud platform.

11. The non-transitory computer readable storage medium of claim 8 wherein the method further comprises, subsequently to the deploying:
retrieving information for accessing the component; and
synchronizing the information with the other components.

12. The non-transitory computer readable storage medium of claim 8 wherein the details for communicating with the cloud platform are stored in a cloud registry maintained by the computer system.

13. The non-transitory computer readable storage medium of claim 8 wherein the method further comprises:
receiving a second request to configure and initiate an FL job on the component and the other components, the second request including job parameters and configuration information;
for each component:
retrieving further details for communicating with the component; and
sending the job parameters and configuration information to the component in accordance with the retrieved further details; and
initiating the FL job on the component and the other components.

14. The non-transitory computer readable storage medium of claim 13 wherein the method further comprises:
receiving a third request to monitor a status of the component or the other components, monitor cloud resource consumption for the component or the other components, or take one or more actions on the in-progress FL job; and
processing the third request by communicating with the component or the other components, or with one or more of the plurality of cloud platforms.

15. A computer system comprising:
a processor; and
a non-transitory computer readable medium having stored thereon program code that, when executed, causes the processor to:
receive a first request for deploying a component of a federated learning (FL) framework on a cloud platform in a plurality of cloud platforms, wherein the plurality of cloud platforms store local datasets, and wherein the component is designed to work in concert with other components of the FL framework deployed on other cloud platforms in the plurality of cloud platforms in order to train a machine learning (ML) model on the local datasets without transferring the local datasets outside of their respective cloud platforms;
retrieving details for communicating with the cloud platform; and
deploying the component on the cloud platform in accordance with the retrieved details.

16. The computer system of claim 15 wherein the plurality of cloud platforms include different public cloud platforms.

17. The computer system of claim 15 wherein the plurality of cloud platforms include at least one public cloud platform and at least one private cloud platform.

18. The computer system of claim 15 wherein the program code further causes the processor to, subsequently to the deploying:
retrieve information for accessing the component; and
synchronize the information with the other components.

19. The computer system of claim 15 wherein the details for communicating with the cloud platform are stored in a cloud registry maintained by the computer system.

20. The computer system of claim 15 wherein the program code further causes the processor to:
receive a second request to configure and initiate an FL job on the component and the other components, the second request including job parameters and configuration information;
for each component:
retrieve further details for communicating with the component; and
send the job parameters and configuration information to the component in accordance with the retrieved further details; and
initiate the FL job on the component and the other components.

21. The computer system of claim 20 wherein the program code further causes the processor to:
receive a third request to monitor a status of the component or the other components, monitor cloud resource consumption for the component or the other components, or take one or more actions on the in-progress FL job; and
process the third request by communicating with the component or the other components, or with one or more of the plurality of cloud platforms.
